(19) United States
(12) Patent Application Publication
(10) Pub. No.: US 2003/0236169 A1
(43) Pub. Date: Dec. 25, 2003

(54) Method for producing a superconducting circuit

(76) Inventors: Wolfgang Lang, Vienna (AT); Dieter Bauerle, Altenberg (AT); Johannes D. Pedarnig, Linz (AT); Ewald Cekan, Leopoldsdorf (AT); Elmar Platzgummer, Vienna (AT); Hans Loschner, Vienna (AT)

Correspondence Address: Finnegan, Henderson, Farabow,, Garrett & Dunner, L.L.P., 1300 I Street, N.W., Washington, DC, 20005-3315, US

(21) Appl. No.: 10/342,260

(22) Filed: Jan. 15, 2003

(30) Foreign Application Priority Data
Jan. 17, 2002 (AT) A 75/2002

(51) Int. Cl. H01B 1/00

(52) U.S. Cl. 505/100

(57) ABSTRACT

For producing a superconducting circuit, a film (12) consisting of a cuprate superconductor material is generated on a substrate (13), wherein the superconductor material is in the superconducting state at an operating temperature of the superconducting circuit to be produced, and then the film is irradiated by projecting an energetic ion radiation onto the film through a mask (11) positioned at a distance from the film and protecting selected areas of the film from being irradiated, the mask comprising a structure pattern transparent to the ion radiation but otherwise opaque to the ion radiation. Areas (14) not protected by the mask are irradiated with an ion dose being sufficiently low to avoid degradation of the crystal structure of the first film but being sufficient to inhibit superconductivity of the film with respect to the operating temperature; ion doses are preferably in the range of 0.8·10¹⁵ and 2·10¹⁵ ions/cm² or below. The areas (15) of the film thus protected from irradiation form film portions which, at least at the operating temperature, act as a superconducting circuit.

### FIELD OF THE INVENTION AND DESCRIPTION OF PRIOR ART

The present invention relates to a method for producing a superconducting circuit, wherein a cuprate superconducting film is generated on a substrate and this film is then irradiated with an energetic ion radiation, with the exception of selected areas of the film which are protected from being irradiated, the areas of the superconducting film not affected from irradiation defining the superconducting circuit to be produced.

Oxide superconductor materials, in particular cuprate superconductors, also known as so-called high-T_{C} superconducting materials, are known as a group of superconducting materials which show distinct physical features, the most noteworthy being the ability to reach comparatively high temperatures for the onset of superconductivity. For YBa₂Cu₃O₇₋ₓ (YBCO), for instance, critical temperatures (T_{C}) as high as 92 K were found, which is well above the boiling point of liquid nitrogen (77 K). For the sake of conciseness, these superconductors with high critical temperatures (i.e., above about 40 K) are referred to as HTS in the following.

Electronic devices fabricated from thin film of superconductors offer several advantages over conventional semiconductor devices, such as higher operating speed, lower losses, and the possibility to implement new types of devices, like Josephson junctions, SQUIDs, flux gates, etc. One major disadvantage of superconducting circuits produced from conventional metal and alloy superconductor materials, such as Nb₃Sn, is the need to cool the device to very low temperatures during operation using liquid helium or hydrogen, requiring large cooling apparatus. On the other hand, devices fabricated from HTS can be operated in a temperature region that can be easily accessed by cooling with liquid nitrogen or electrical cooling machines operated with helium gas, substantially reducing the cooling overhead.

The fabrication of HTS superconducting circuits and devices needs a reliable method for patterning thin films of HTS deposited on a substrate. For some applications structures of very small lateral dimensions are needed as well. The principal feasibility of fabrication of many superconducting devices using HTS has been demonstrated, such as Josephson junctions, SQUIDs, current-controlled switches, microwave delay lines, filters, mixers, and several other devices.

Commonly used techniques for structuring a HTS film involve the removal of the HTS film by chemical etching or ion milling where the structures are defined by a layer of photoresist on top of the HTS film. This causes underetching and unfavorable chemical reactions during the process; moreover, those methods result in the formation of a patterned surface. Such surface texture is a major disadvantage for growing additional epitaxial layers of HTS, a protection layer, or other material. Strain on the edges of the patterned film and the wavelength of the light used for exposing the photoresist limit the minimum size of device structures. In addition, such techniques involve several processing steps to fabricate a very simple circuit, e.g., a superconducting connecting line between two devices.

Other known techniques employ ion bombardment to inhibit superconductivity on certain regions of a thin HTS film. Methods of this kind are disclosed in the EP 0 296 973 A2 and the U.S. Pat. No. 5,795,848. Apart from using the conventional photoresist method to mask the ion beam, these methods either use post-annealing to become effective or used a high ion dose, at which the crystallographic structure of the HTS is severely damaged or even destroyed, i.e. it becomes amorphous. Although the latter technique could in principle be used for patterning of devices on a scale not too small, it is unsuitable for multi-layer devices where the task is to prepare additional epitaxial layers of HTS or other similar materials on top of the ion bombarded HTS film.

In an article of A. S. Katz et al.., Appl. Phys. Lett. 72 (1998) 2032-2034, the generation of thin film YBCO Josephson junction by means of ion damage is shown. According to the article, 200 keV Ne⁺ ions were used to produce weak links which showed a remarkable stability at room temperature and in which the superconducting property is modified (as expressed in a lowered transition temperature T_{C}) due to the disorder induced in the film. However, the article only refers to the properties of the weak-link, but does not refer to the properties of the HTS material. The article of G. Van Tendeloo, J. Mater. Res. 6 (1991) 677-681, discusses ion irradiation of HTS and shows that ion irradiation similar to that used by Katz et al. leads to areas of deformation (with defects and amorphous areas), resulting in a granular, inhomogeneous system in which the superconducting behavior is determined by percolation paths. The article of S. Matsui et al., Nucl. Instrum. Meth. Phys. Res. B39 (1989) 635-639 shows that the transition temperature T_{C} is reduced only to a small extent by ion irradiation with 200 keV Ne⁺, but the onset of the superconducting transition is practically unchanged, which is a typical sign for an inhomogeneous superconductor with a percolation transition. This result is further supported by O. Meyer et al., Nucl. Instrum. Meth. Phys. Res. B65 (1992) 539-545, where 600 keV Ar²⁺ was used, and F. Kahlmann et al., Appl. Phys. Lett. 73 (1998) 2354-2356, using 200 keV oxygen ions. From these findings, one would not expect that an overall suppression of superconductivity may take place in a HTS material without taking into account a degradation of the material structure, at least to the extent of defect areas and/or partial amorphization.

### SUMMARY OF THE INVENTION

It is an aim of the present invention to offer a method for producing a superconducting circuit which avoids the above-mentioned disadvantages of the prior art. This aim is met by a method which, according to the invention, comprises the following steps:

generating a superconducting film on a substrate, the superconducting film consisting of a cuprate superconductor material which is in the superconducting state at an operating temperature of the superconducting circuit to be produced,

irradiating said film with an energetic ion radiation by projecting said energetic ion radiation onto said film through a mask positioned at a distance from the film, the mask protecting selected areas of said film from being irradiated,

the areas of the superconducting film thus protected from irradiation defining the superconducting circuit to be produced at the operating temperature,

wherein in the irradiation step, areas not protected by the mask are irradiated with an ion dose being sufficiently low to avoid degradation of the crystal structure of the superconducting film but being sufficient to inhibit superconductivity of the film with respect to the operating temperature.

The invention allows fabrication of small structures in cuprate superconductor films. A thin film of a HTS with a well-defined crystallographic structure is prepared on a suitable substrate material; the presence of the crystallographic structure ensures a high critical temperature T_{C} of the film, i.e., above the operating temperature of the superconducting circuit to be manufactured, e.g., the temperature of liquid nitrogen (77 K). Selected parts of the film are subjected to an ion beam. This ion irradiation causes an increase of electrical resistance of the material and a reduction of the critical temperature below the operating temperature. The dose of the ion irradiation is chosen to be sufficiently high so as to induce this suppression of superconductivity, but still low (as compared to known ion irradiation methods) so as to not degrade the crystal structure of the HTS film. It is one aspect of the invention that these two conditions are not mutually exclusive, in contrast to the tacit assumption of prior art that suppression of superconducting behavior must be triggered by a treatment strong enough to also cause deterioration of the crystalline order.

The parts of the film to be exposed to ion radiation are defined by means of a mask which is positioned in front of the film as seen in the direction of the ion beam. The mask, comprising a foil having a number of openings through which the ion radiation can pass, may be positioned directly before the film at a small distance from the film or is projected on the film using a projection technique. The invention makes it possible to fabricate superconducting circuits, single-layer and multi-layer superconducting devices of small dimensions for various electronic applications.

The use of a masked irradiation, such as ion proximity printing or masked ion projection, offers the possibility to achieve high resolutions of the structures produced, e.g. of dimensions well below the μm range. In a preferred mode of the invention, the structures of the film portions comprise structures of dimensions in the range of 10 to 100 nm. For instance, the production of junctions typically having dimensions of about 10-100 nm are possible according to the invention. Moreover, masked irradiation enables high throughput as the whole circuit structure is transferred to film in a single step, as opposed to e.g. focused ion beam techniques which require writing of each spot to be developed.

One major advantage of the present invention is that it disposes of the use of a photoresist, instead employing a contactless method without the need to bring the circuit device in physical contact with wet-etching solutions or the like, or structuring devices which may physically interfere with the surface. In fact, the invention ensures that the spatial and crystallographic structure of the film is not degraded. As one consequence, the arrangement of other layers which are neighboring to or positioned above the irradiated film is not disturbed; for example, on top of a HTS film which has been irradiated to form a circuit pattern, deposition of additional layers is possible with the deposition characteristics staying unchanged irrespective whether the underlying film is irradiated or not. First experiments showed that the circuit structures manufactured by the method according to the invention exhibited an unusual high stability with respect to their electrical properties.

The invention provides a method for patterning circuits and devices into HTS films deposited on suitable substrates. As an example, at a selected operating temperature, e.g. at 77 K, the circuit consists of two different regions. One, where superconductivity is inhibited and the material exhibits reduced electrical conductivity, and other regions, where the material remains superconducting. Thus, an electrical charge is predominantly transported along the superconducting parts of the film. In this operating condition the inhibited regions serve as quasi-insulating material to separate the superconducting paths from each other. In addition, the inhibited regions may be patterned on a small length scale and then act as a weak coupling between neighboring superconducting regions in order to form devices that operate on the basis of weak coupling of two or more superconducting quantum subsystems. One example for such device is the Josephson junction.

In the first step, at least one thin epitaxial film of HTS materials are prepared. HTS materials suitable for the invention include, but are not limited to, the materials listed in Table 1. The HTS film is deposited by known methods, such as pulsed laser deposition, on a suitable substrate material; preferable substrate materials are listed in Table 2. (Si/YSZ stands for yttria-stabilized zirconia on silicon, and RABiTS™ for rolling-assisted biaxial textured substrates, e.g., produced from Ni tapes). The thin films may be further provided with electrical contacts and a protection layer, e.g. SiOₓ or SrTiO₃, to inhibit deterioration of the properties of the circuit, when stored or operated in unfavorable chemical environment. The contacts and the protection layer can be formed before any processing of the thin films described in the following.

Another aspect of the invention is the use of ions, such as hydrogen ions (H⁺) or noble gas (He⁺, Ne⁺, Ar⁺, Kr⁺, Xe⁺) ions, to a low ion irradiation density and in an energy range at which the crystalline structure of the HTS is not altered essentially; see Table 3 for more details of the ion parameters. It should be noted that the ion energies are rather low, thus there is little ion damage imparted to the superconducting film which retains its well-ordered crystallographic order; in fact, methods for inspection of crystallographic degradation, such as X-ray diffraction using so-called rocking curves, indicated a negligible change (if at all) of the crystallographic order in a film irradiated and structured according to the invention. As to the influence of the ion mass, it is expected that the ion dose needed to suppress superconductivity will be lower for heavier ions; nonetheless the effect of suppression of superconductivity while maintaining the crystalline structure is best pronounced when light ions are used.

Experiments of prior art indicated that suppression of superconductivity is achieved due to heavy structural changes of the crystal lattice induced by the ion irradiation. In particular using heavy ions resulted in the formation of roughly cylindrical damage tracks along the ion path through the material. The typical diameter of such a damage track is about 5 nm. At low dose, when the damage tracks do not overlap, a percolative superconducting transition was observed. The characteristic signature is that the resistivity starts to decrease at a temperature close to the initial T_{c}, but zero-resistance is achieved only when percolating current paths connect at significant lower temperatures. To fully inhibit superconductivity a rather high dose has to be used in order that the damaged regions overlap and no percolation path can be established. The heavy defect structure and the inhomogeneous properties of a HTS film after such process is not suitable for small practical devices.

In contrast to prior art, the present invention proposes to use light ions and rather low energies. Although it was expected from present knowledge that the interaction of a HTS film with light ions will not lead to a significant reduction of T_{c} unless the crystallographic structure is severely altered, we have found that using light ions with rather low energy and dose in a suitable range, superconductivity can be inhibited while the crystallographic structure is essentially preserved. The origin of this effect appears to be connected with the complicated and sensitive structure of HTS, where even small displacements of certain atoms can destroy superconductivity although the overall structural framework remains intact. This particular feature of the present invention allows for an exact lateral definition of the interface between superconducting and non-superconducting phases and minimizes mechanical strain at the interface. In addition, the conservation of the original structural framework permits the epitaxial growth of additional HTS layers or other materials with similar lattice constants. This is a major achievement over prior art techniques, where the crystal structure of the HTS material had to be significantly damaged or changed to amorphous in order to inhibit superconductivity.

In view of the above, for the irradiation step one suitable group of ions are light ions used in the ion radiation; in the present disclosure, the term light ions refers to neon and ions lighter than neon, i.e., ions of atomic number up to 10. Preferably, the ions used in the irradiation step are hydrogen ions or noble gas ions. In the latter case values of ion energy and ion dose which are especially suitable are listed in Table 3 for the respective ion species. Best results are expected when either helium ions are used and the ion dose is in the range between 0.8·10¹⁵/cm² and 2·10¹⁵/cm², or hydrogen ions are used and the ion dose is in the range between 2·10¹⁵/cm² and 4·10^{15/}cm².

The selection of the regions in the HTS film that are subjected to the ion irradiation is performed, for instance, by placing a stencil mask at small distance to the HTS film and, thus, directly transferring the structure of the mask to the film at the same scale. As an alternative, the regions can be defined by projecting the structure of a mask with reduced scale to the surface of the HTS film. Although not limited to this special case, the invention provides a one-step process for establishing arbitrarily complex structures in the HTS film, where the structures are defined by superconducting regions and regions where superconductivity is inhibited. No further process step is required for producing the circuit structure.

It should be appreciated that the invention can be used to pattern structures into HTS materials in applications where known techniques, like wet chemical etching, lead to destruction of the HTS thin film. An example for such material is the system Hg—Ba—Ca—Cu—O. When using a protection layer, the invention provides direct patterning of the HTS thin film through this protection layer, such that a ‘buried active layer’ can be formed. Thus, in one variant of the invention, before the irradiating step, at least one cover layer is generated on top of the first film, and the irradiation of said film is done through said at least one cover layer.

The invention provides a method for patterning superconducting circuits and devices into HTS films deposited on suitable substrates by inhibiting superconductivity and reducing the normal conducting properties of the HTS film, while leaving the crystalline structure essentially unchanged. Moreover, a one-layer structure of arbitrary complexity that covers a large area can be fabricated with the method according to the invention. The exposure of parts of the film to an ion beam is controlled by either a stencil mask located at short distance from the surface of the HTS film, or, alternatively, by projecting the required structure with a reduced scale on the HTS surface. The masked areas keep their superconducting properties, whereas superconductivity is inhibited, or T_{C} reduced, in the areas exposed to the ion beam. This method is very efficient, can be applied to HTS films of large area, and, thus, allows for a high throughput in commercial production environment.

As an extension of this technique, additional layers of HTS or other materials may be grown on the surface of the film already irradiated and multi-layer structures established. Proper selection of the ion energy allows for a confinement of the inhibition process to the top layer, without changing the formerly established circuits and devices in lower-lying layers. In this respect, the application of an electrically non-active protection layer of appropriate thickness can be used as described previously during inhibition of the first active layer, but with the additional purpose of acting as a stopping layer to ions for subsequent inhibition processes of additional layers grown on top of the former ones. According to this further development of the invention, after the irradiation step performed with the first film, at least one further film of a cuprate superconducting material is produced on the first film, and the further film, or each of the further films as the case may be, is irradiated in a likewise manner as the first film using a respective second mask having a respective second structure pattern, the areas of the first and further films protected from irradiation forming film portions which, at least at the operating temperature, act as a superconducting circuit.

### BRIEF DESCRIPTION OF THE DRAWINGS

In the following, the present invention is described in more detail with reference to the drawings, which show schematically:

FIG. 1 the change of the resistivity of an YBCO sample as a function of the temperature with different doses of ion irradiation;

FIG. 2 the patterning of a superconducting film according to the invention;

FIG. 3 the resulting patterned film;

FIGS. 4 to 6 various patterns of superconducting circuits according to the invention;

FIG. 7 the patterned film of FIG. 3 with a protecting cover layer; and

FIGS. 8 and 9 a multi-layer superconducting circuit.

### DETAILED DESCRIPTION OF EMBODIMENTS OF THE INVENTION

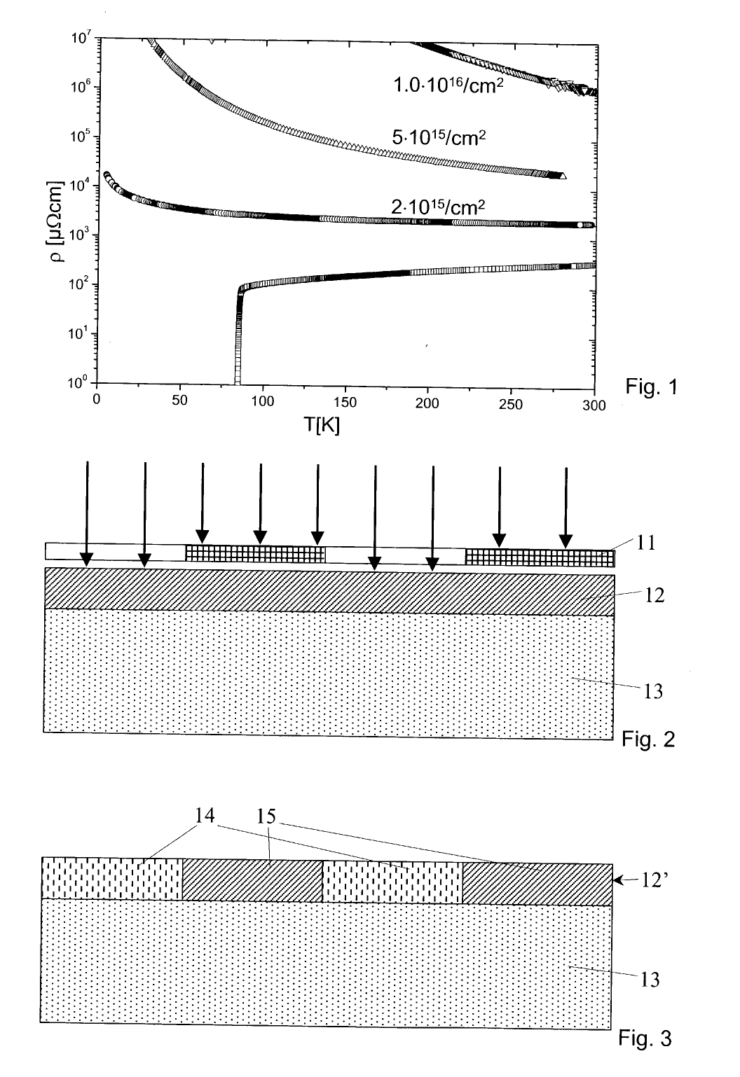

FIG. 1 shows the change of the resistivity, in μΩcm, of a representative HTS, namely YBCO, as a function of the temperature at different irradiation doses, namely the initial resistivity function after preparation (square symbols) and after subsequent, cumulative irradiation with 75 keV He⁺ ions with total dose 2·10¹⁵, 5·10¹⁵, and 1.0·10¹⁶ ions/cm², respectively. The YBCO film was generated on a MgO substrate by pulsed laser deposition and had a thickness of 100 nm; after deposition, the film was covered with a silicon oxide protective layer of a thickness of about 175 nm by means of electron-beam evaporation of SiO₂ granulate. The graph demonstrates the inhibition of superconductivity and the increase of the resistivity after ion irradiation, and that already with a low ion dose—in this example with about 2·10¹⁵ ions/cm² (circle symbols)—it is possible to suppress superconducting behavior and replace it by a behavior exhibiting a very small temperature-dependent variation of resistivity.

Table 3 shows results obtained with various ions, ion energies and doses for a HTS film of usual film thickness (in the order of about 50 nm to several 100 nm). As can be seen from the data, heavier ions (i.e., heavier than Ne) need a higher ion energy, which is necessary for that the ions are not implanted in the film but pass through it. In particular light ions can provide for subtle defects in the crystal structure which are not or hardly visible even in X-ray rocking curves but which result in an effective suppression in the superconducting behavior nonetheless. Possibly, this behavior is caused by changes in the arrangement of oxygen atoms in the crystal structure while the position of the heavier atoms in the HTS structure remains intact. This effect is most pronounced with hydrogen or helium ions, and to a lesser degree with intermediate ions such as oxygen or neon ions. Best results are expected for He⁺ at about 75 keV to an ion dose of about 0.8·10¹⁵/cm² to 2·10¹⁵/cm²; for hydrogen ions, the ion dose should be chosen somewhat higher, i.e. 2·10¹⁵/cm² to 4·10¹⁵/cm².

It should also be noted that with ion doses exceeding the cited values, experimental results from X-ray rocking curves did show changes in the crystalline structure indicating an onset of amorphization of the sample.

Preferred embodiments of a HTS circuit prepared according to the invention is shown in FIGS. 2 to 9. In FIG. 2 a cross-sectional view of a superconducting film is shown which is prepared to obtain a superconducting circuit. A thin film of a cuprate superconductor 12, for example YBCO or another material listed in Table 1, is grown on a suitable substrate 13 such as MgO or SrTiO₃ (Table 2) by one of the methods cited above. Then the film is irradiated with, e.g., ion radiation of 75 keV He⁺ ions at a radiation density of 2·10¹⁵ ions/cm². The arrows in FIG. 2 symbolize the ion irradiation, which is directed preferably with a normal incidence relative to the surface of the substrate; a small angle, e.g. between 0 and 20°, relative to the surface normal of the substrate is also possible. A mask foil 11 which contains a structure pattern with parts transparent to the ion irradiation (shown white in FIG. 2) and others that are opaque (shown cross-hatched) is used to define the position and shape of the circuit that is to be defined in the superconducting film 12.

FIG. 3 shows a cross-sectional view of the superconducting circuit resulting from irradiation with light ions. The superconducting film 12′ is now structured to represent a superconducting circuit according to the invention. In the regions 14 of the superconducting film 12′ that were exposed to irradiation, superconductivity is suppressed so that the superconducting transition is below 4 K. Thus, the material is not superconducting at the operating temperature of the circuit, e.g., at 77 K. Those regions 15 of the HTS film 12′ which were protected from being irradiated by the opaque parts of the mask 11 remain in the superconducting state at the operating temperature. Thus, a planar device structure, consisting of superconducting and non-superconducting regions, can be patterned into the initially fully superconducting film.

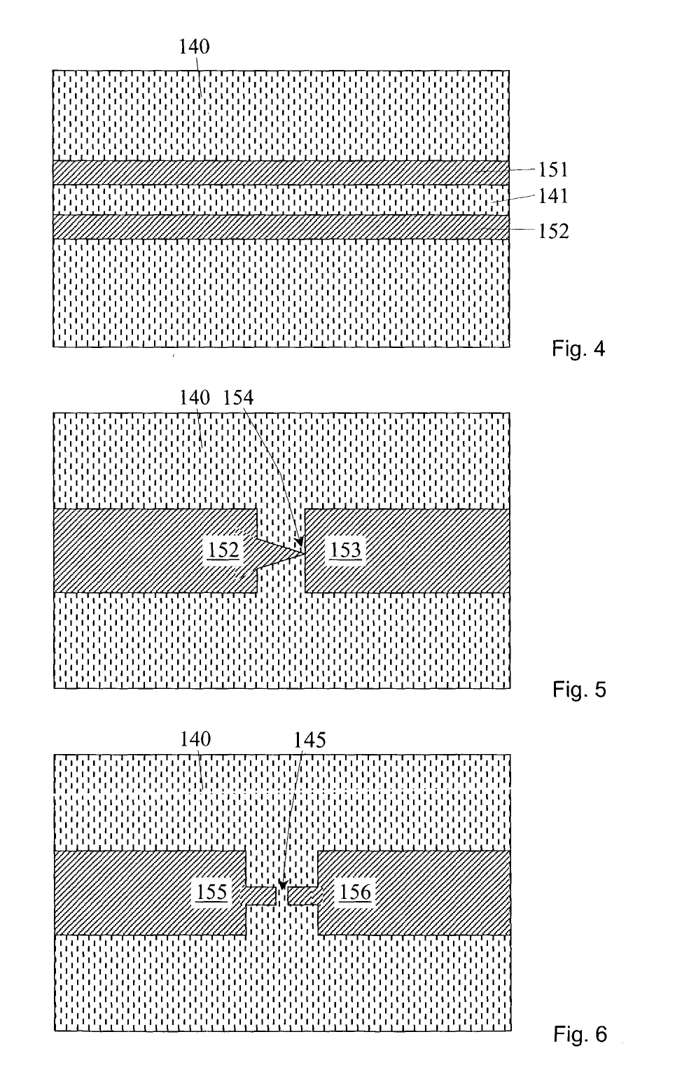

FIG. 4 shows a plan view of a superconducting circuit which may be used to connect different devices. Electrical signals are transmitted along the strip-line structure that consists of two parallel lines 151,152 of superconducting material that are separated by regions 140,141 of the film where superconductivity is inhibited. Of course, this circuit can be modified for any number of transmission lines, including the minimum of a single line.

FIG. 5 shows a plan view of a first superconducting circuit, namely, a Josephson junction. The implementation of the Josephson effect is achieved by two superconducting regions 153,154 that are connected via a strongly constrained junction 154. A typical cross section required is smaller than 100×100 nm² and can be achieved with thin films and the method described here. The rest of the film 140 is either normal conducting or insulating at the operating temperature. The resulting point-contact 154 between the superconducting strips leads to a weak coupling of the superconducting order parameter and, thus, to the electrical properties typical for a Josephson element.

FIG. 6 shows another way to realize a superconducting circuit having a Josephson element with properties similar to those of FIG. 5. Two superconducting regions 155,156 are separated by a narrow channel of normal conducting or insulating material 145. The distance of the superconducting regions (i.e., the width of the channel 145) should be small enough to ensure a weak-link (e.g. tunneling) overlap of the superconducting wave functions of the two regions 155,156; for YBCO material, this means that the distance should typically be smaller than 100 nm.

The Josephson elements as depicted in FIGS. 5 and 6 can be used as basic functional element of other, more complex, superconducting circuits, which are formed by a combination of one or multiple of the said circuits and connecting lines as presented in FIG. 4.

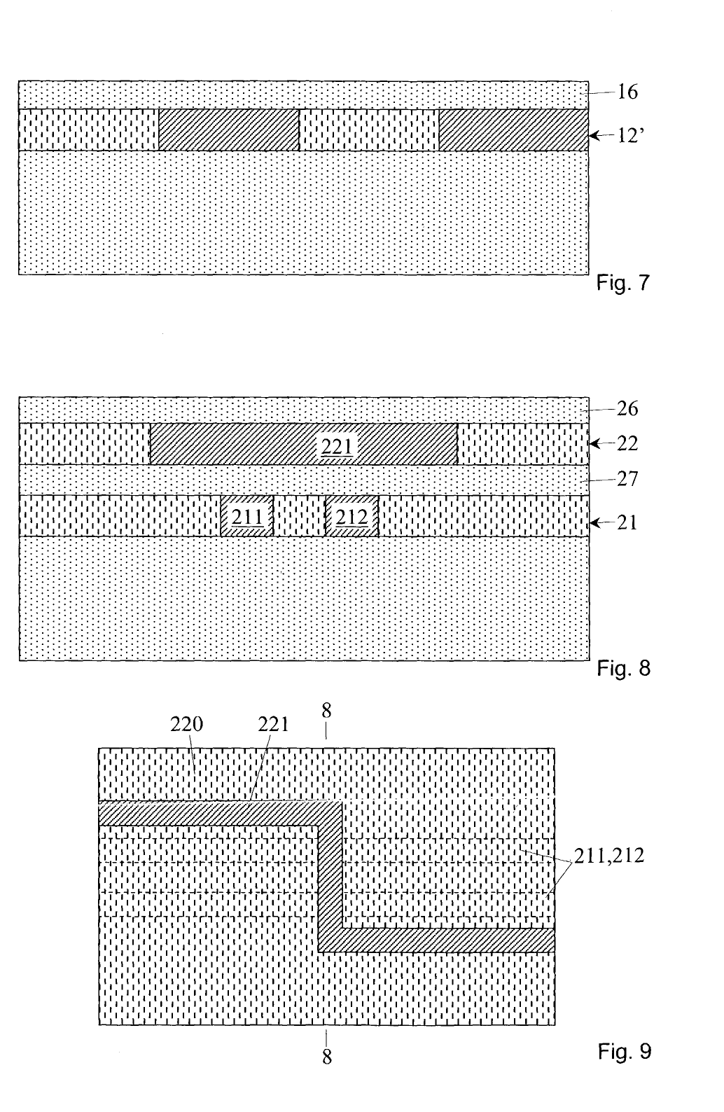

Referring to FIG. 7, a cover layer 16 may by provided in order to protect the superconducting circuit layer 12′ from mechanical and atmospheric damage. The cover layer may be applied after the structuring step of the superconducting film by ion irradiation; in a preferred variant, however, the cover layer is first generated on top of the superconducting film, and then the film is structured through the cover layer. The cover layer will typically have a thickness of 100 to 500 nm and consist of a material like SrTiO₃, MgO, SiOₓ or another material listed in Table 2.

The invention can, of course, be used to produce multi-layer superconducting devices. In such a multi-layer device, a sequence of superconducting layers is present. An example is shown in FIGS. 8 and 9; FIG. 8 represents a cross-sectional view of the layout of FIG. 9 along the line 8. As can bee seen from FIG. 8, two superconducting circuit layers are present, wherein on top of a first film 21 a second film 22 is provided. The second film generated and structured in a like manner as the first film, but after generation and structuring of the first film is done.

A separating layer 27 may be present to insulate the films 21,22 if needed; the layer 27 has, for instance, a thickness of 200 nm or more. Furthermore, a cover layer 26 may be provided. In the example shown, the first film 21 represents a circuit with two strip-lines 211,212 as in FIG. 4, whereas the second film 22 realizes a third line 221 which traverses the two lines of the first film. FIG. 9 illustrates the layout of the second film 22 in a plan view with the cover layer 26 removed. Thus, a superconducting crossover can be realized, in which two superconducting wires are separated by an insulating layer, as needed in the fabrication of, for instance, a superconducting pickup coil for a SQUID device.

The separating layer 27 can also serve as a stop layer for radiation, in order to protect the first film during the structuring irradiation of the second film. In this case, the thickness of the separating layer may advantageously by chosen to be sufficient to prevent ions to reach the first film 21. Thus, as 75 keV helium ions have an average stop length of 280 nm in SrTiO₃, a separating layer of this material should be chosen to have at least a thickness of 280-300 nm.

TABLE 1
Examples of HTS materials suitable for the invention

| | | | patterning by wet |
|---|---|---|---|
| Material | Parameters | T_{c} [K] | chemical etching |
| REBa₂Cu₃O_{7-δ} | 0 < δ < 0.8; | 0-90 | yes |
| | RE = Y, La, Nd, | | |
| | Sm, Eu, Gd, Tb, | | |
| | Dy, Ho, Er, Tm, | | |
| | Yb, Lu | | |
| YBa₂Cu₄O₈ | | 80 | yes |
| Y₁₋ₓCaₓBa₂Cu₃O_{y} | 0 < x < 0.3, | 70-92 | no |
| | 6.7 < y < 7 | | |
| YBa₂₋ₓLaₓCu₃O_{y} | 0 < x < 0.8, | 0-92 | |
| | 7 < y < 7.5 | | |
| Bi₂Sr₂CaCu₂O_{y} | y˜8 | 90 | yes, low quality |
| Bi₂Sr₂Ca₂Cu₃O_{y} | y˜10 | 110 | yes, low quality |
| TlBa₂CaCu₂O_{y} | y˜7 | 90 | |
| TlBa₂Ca₂Cu₃O_{y} | y˜9 | 110 | |
| Tl₂Ba₂CuO_{y} | y˜6 | 90 | |
| Tl₂Ba₂CaCu2O_{y} | y˜8 | 110 | |
| Tl₂Ba₂Ca₂Cu₃O_{y} | y˜10 | 125 | |
| HgBa₂CuO_{y} | y˜4 | 95 | no |
| HgBa₂CaCu₂O_{y} | y˜6 | 120 | no |
| HgBa₂Ca₂Cu₃O_{y} | y˜8 | 133 | no |
| Hg₁₋ₓReₓBa₂CaCu₂O_{y} | 0 < x < 0.25, y˜6 | 120 | no |
| Hg₁₋ₓReₓBa₂Ca₂Cu₃O_{y} | 0 < x < 0.25, y˜8 | 133 | no |

TABLE 2
Substrate materials

| | | | |
|---|---|---|---|
| SrTiO₃ | NdAlO₃ | LaSrGaO₄ | Sr₂AlTaO₆ |
| MgO | YAlO₃ | CaNdAlO₃ | GdBa₂NbO₆ |
| A1₂O₃ | PrCaO₃ | CaYAlO₄ | Y₃Al₅O₁₂ |
| CeO₂ | KTaO₃ | SrRuO₄ | Gd₃Ga₅O₁₂ |
| LaAlO₃ | YbFeO₃ | Mg₂TiO₄ | MgLaAl₁₁O₁₉ |
| LaGaO₃ | LiNbO₃ | MgAl₂O₄ | Si/YSZ |
| NdGaO₃ | LaSrAlO₄ | | RABiTS ™ |

TABLE 3
Ion parameters

| ion species | ion energy (range) | | ion dose (range) | |
|---|---|---|---|---|
| H⁺ | 10-200 | keV | 5 · 10¹⁴-1 · 10¹⁶ | ions/cm² |
| He⁺ | 20-200 | keV | 1 · 10¹⁴-5 · 10¹⁵ | ions/cm² |
| Ne⁺ | 50-500 | keV | 2.5 · 10¹³-1 · 10¹⁵ | ions/cm² |
| Ar⁺ | 0.08-1 | MeV | 1 · 10¹³-5 · 10¹⁴ | ions/cm² |
| Kr⁺ | 0.1-2 | MeV | 3 · 10¹²-1 · 10¹⁴ | ions/cm² |
| Xe⁺ | 0.2-3 | MeV | 1 · 10¹²-3 · 10¹³ | ions/cm² |

We claim:

1. A method for producing a superconducting circuit, comprising the following steps:
generating a first film on a substrate, the first film consisting of a cuprate superconductor material which is in the superconducting state at an operating temperature of the superconducting circuit to be produced,
irradiating the first film with an energetic ion radiation by projecting said energetic ion radiation onto the film through a mask positioned at a distance from the film and protecting selected areas of the film from being irradiated, the mask comprising a structure pattern transparent to the ion radiation but otherwise opaque to the ion radiation,
the areas of the first film thus protected from irradiation forming film portions which, at least at the operating temperature, act as a superconducting circuit,
wherein in the irradiation step, areas not protected by the mask are irradiated with an ion dose being sufficiently low to avoid degradation of the crystal structure of the first film but being sufficient to inhibit superconductivity of the film with respect to the operating temperature.

2. The method of claim 1, wherein
before the irradiating step, at least one cover layer is generated on top of the first film, and the irradiation of said film is done through said at least one cover layer.

3. The method of claim 1 or 2, wherein
after the irradiation step performed with the first film, at least one further film of a cuprate superconducting material is produced on the first film, and the further film, or each of the further films as the case may be, is irradiated in a likewise manner as the first film using a respective second mask having a respective second structure pattern, the areas of the first and further films protected from irradiation forming film portions which, at least at the operating temperature, act as a superconducting circuit.

4. The method of any one of claims 1 to 3, wherein
the structures of the film portions comprise structures of dimensions in the range of 10 to 100 nm.

5. The method of any one of claims 1 to 4, wherein
in the irradiation step, light ions (atomic number up to 10) are used in the ion radiation.

6. The method of any one of claims 1 to 4, wherein
the ions used in the irradiation step are hydrogen ions or noble gas ions.

7. The method of claim 6, wherein
an ion energy and an ion dose is used as listed in Table 3 for the respective ion species.

8. The method of claim 6, wherein
helium ions are used and the ion dose is in the range between 0.8·10¹⁵/cm² and 2·10¹⁵/cm².

9. The method of claim 6, wherein
hydrogen ions are used and the ion dose is in the range between 2·10¹⁵/cm² and 4·10¹⁵/cm².
